(19) United States
(12) Patent Application Publication
(10) Pub. No.: US 2002/0121047 A1
(43) Pub. Date: Sep. 5, 2002

(54) Preparing small awny seed

(76) Inventor: Tommy K. Thrash, Littlefield, TX (US)

Correspondence Address: WENDELL COFFEE, P.O. BOX 3726, LUBBOCK, TX, 794523726

(21) Appl. No.: 09/946,493

(22) Filed: Sep. 5, 2001

Related U.S. Application Data
(60) Provisional application No. 60/231,247, filed on Sep. 8, 2000.

(51) Int. Cl. A01B 79/02

(52) U.S. Cl. 47/58.1 SE

(57) ABSTRACT

Awny seed are prepared for planting by mechanical planters. The awny seed are prepared for removing the awn by chilling the see to less than 5° centigrade. The awn is removed from the chilled seed by flaming. The deawned seed are sprayed with a tackifier while being tumbled. Then the seed are sprinkled with a mixture of a high density material, a hydrophilic substance and optionally a fertilize and a growth regulator. While being tumbled, thereby producing a coated seed.

### REFERENCE TO PROVISIONAL PATENT APPLICATION:

The applicant claims the benefit of his Provisional Application No. 60/231,247, filed Sep. 8, 2000.

### BACKGROUND OF THE INVENTION

(1) Field of the Invention

This invention relates to preparing seed for planting and more particularly preparing small awny seed for planting.

Awny seed present difficulty in planting with mechanical planters. The awn on the seed tends to cause the seed to form bunches. This prevents the seed from being planted individually at regular spaces which is desirable. Also, the small seed often have difficulties because normally they are planted very shallow. Then rains or irrigation often wash them away. In other situations, high winds often blow the seed away. Farmers have ordinary skill in the art of preparing seed for planting.

(2) Description of the Related Art

Before this invention it was known that awny seed could be treated or manipulated to remove the awn from the seed. It was known that this could be done by abrasion or by flaming. However there was a danger in both abrasion and flaming that the seed would be heated to a point to reduce the germination of the seed.

Although the lint on cotton seed is not awn, the cotton fibers attach to cotton seed cause a similar problem. It is known with cotton seed that the lint can be removed either by flame delinting or by mechanical delinting.

### SUMMARY OF THE INVENTION

### (1) Progressive Contribution to the Art

This invention is to solve the problems of planting small awny seed.

First the awn is removed. Because of the heat generated during awn removal, the seed are first chilled to a temperature below 5° centigrade and preferably to lower than −20° centigrade. After chilling, the awn is be removed by flaming the seed. Although flaming is preferable the awn may be removed by abrading the seed. After removing the awn, the seed may be planted in this condition.

In the event that there is a problem with the seed being washed or blown away, the seed may be coated. Coating on seed increases the weight of each individual seed unit so that when it is planted it will have sufficient weight to resist either washing or blowing away. In addition, the coating of the seed may include a hydrophilic material to aid in the germination of the seed. The hydrophilic material will draw moisture from the surrounding soil to help furnish sufficient moisture for the seed to germinate. Also a fertilizer may be included in the coating to aid early growth of the sprouted seed.

### (2) Objects of This Invention

An object of this invention is to remove the awn from awny seed so that it may be advantageously planted with mechanical equipment. Another object of this invention is to coat the seed with a coating which attracts moisture, adds fertilizer and gives enough weight to the seed to remain in the correct position after being planted.

Another object of this invention is to chill the seed before removing the awn to prevent deterioration of germination.

Other objects are to achieve the above with a method that is rapid, versatile, ecologically compatible, energy conserving, efficient, and inexpensive, and does not require highly skilled people to install, operate, and maintain the necessary equipment.

Further objects are to achieve the above with equipment that has a long life, is safe, versatile, efficient, and reliable, yet is inexpensive and easy to maintain and operate.

The specific nature of the invention, as well as other objects, uses, and advantages thereof, will clearly appear from the following description and from the accompanying drawings, the different views of which are not necessarily scale drawings.

### BRIEF DESCRIPTION OF THE DRAWINGS

FIG. 1 is a schematic representation of equipment to perform the method.

FIG. 2 is an enlarged portion of FIG. 1 showing the flame.

FIG. 3 is a cross sectional view of the spike auger, taken on line 3-3 of FIG. 1.

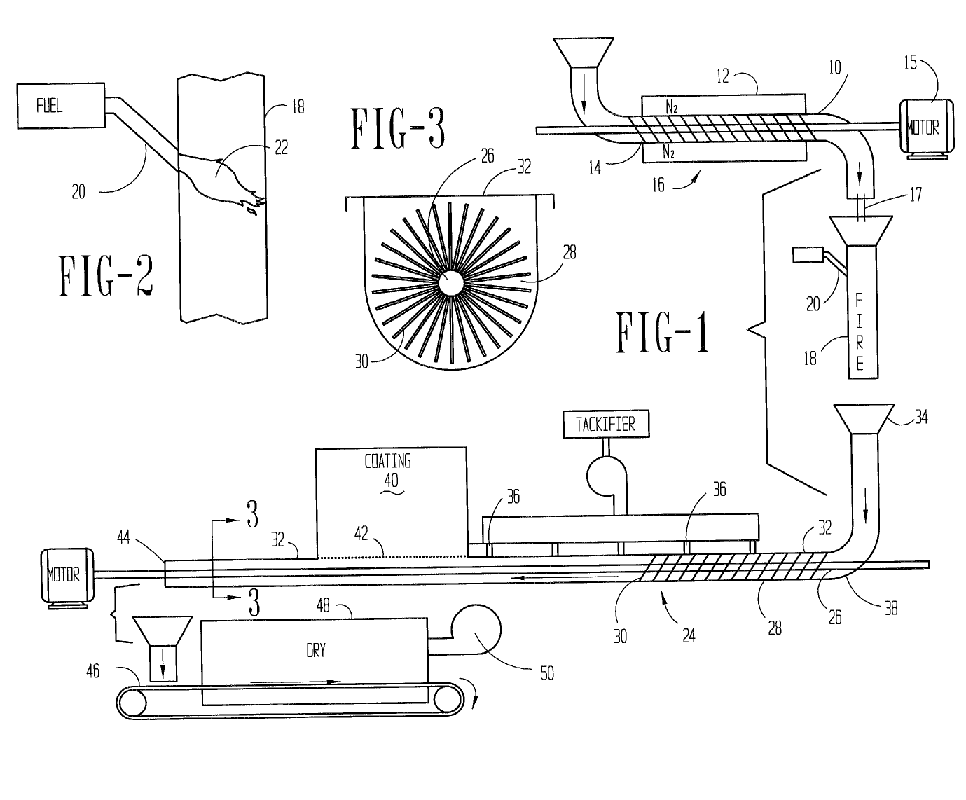

CATALOGS OF ELEMENTS:

| | |
|---|---|
| 10. Metal tube | 32. Covering |
| 12. Jacket | 34. Opening |
| 14. Auger | 36. Nozzles |
| 15. Motor | 38. Entry |
| 16. Chiller | 40. Coating |
| 17. Straps | 42. Opening |
| 18. Flame Tube | 44. Exit |
| 20. Burner | 46. Conveyor Belt |
| 22. Flame | 48. Conveyor Box |
| 28. Trough | 50. Fan |
| 30. Spikes | |

### DESCRIPTION OF THE PREFERRED METHOD

First the seed are chilled before removing the awn. The seed may be chilled by numerous methods. It is possible to chill the seed by lowering the temperature of air well below 0° C. and circulating the chilled air around the seed. Also, they can be chilled with water which is slightly above freezing temperature. Another method of chilling the seed is to emerge them in liquid nitrogen for a short period of time.

The preferred method of chilling the seed is to convey the seed in a metal tube 10 surrounded by a chilling substance, preferably liquid nitrogen and gaseous nitrogen contained in jacket 12. The preferred conveyor is an auger 14 driven by a motor 15.

After the seed are chilled the awn is removed. As stated before, abrasive awn removable is one method of removing the awn.

However, the preferred method, according to this invention is to flame the seed. In this process the seed are conveyed from the chiller 16 to a flame tube 18 having a circular cross section with a vertical axis about 15 feet in length and a diameter of about 1 foot. The flame tube 18 is connected to the metal tube 10 by straps 17. The straps 17 do not prevent atmospheric air from flowing into the fire table 18 . A burner 20 produces a flame 22 which enters the flame tube 18 about 2 feet from the top of the flame tube.(FIG. 2 ) The burner 20 has a downward flowing axis of about 45° from one side of the flame tube 18. Although the flame could be produced by a liquid fuel it is preferred that a gas fuel be used. Normally, the gas would be methane or butane. The flame 22 extends completely across the tube 18, so that all seed flowing down the tube are subject to the flame thus removing the awn from them. The flame normally is 18 inches in length. That is measuring the flame from where it entered the flame tube to about 12 inches below that point.

Since the flame 22 it extends across the tube 18, the length of the flame would be about 18 inches. Looking at FIG. 2 it may be seen that all the seed flowing down the flame tube would be exposed to the flame 22.

After the awn is removed, the seed are coated by a mixture preferable containing the following ingredients: tactifier, high specific gravity substance, hydrophilic material, and fertilizer.

A tactifier may be corn syrup or guar gum. However, there are many other known tactifiers, such as lignosulfonate. The preferred tactifier is Lignocite, a product of Georgia Pacific, Inc. made from lignosulfonate.

The high specific gravity material might be either sand(granulated or powered), bentonite, or iron oxide. Many other high specific gravity materials could be used. Polycryalmide is the preferred hydrophilic material.

The coating may be applied to the seed by agitating the seed and spraying the coating in liquid form onto the agitated seed. The preferable method of agitating the seed is tumbling.

The preferred method for coating the seed after removing the awn may be tumbling the seed in a horizontal spike auger 24. The spike auger is an auger having a horizontal revolving shaft 26 in a trough 28. Spikes 30 in a helical pattern are attached to the shaft 26. The spikes 30 will agitate the seed by lifting the seed and moving the seed along the trough 28. The trough 28 is covered 32 but not sealed.

The preferred length of the auger 28 is about 50 feet. The seed maybe directly into a entry 34 to the auger from the flaming teeth 18. A series of spray 36 nozzles are located above the trough 28 from about 2 feet from the entry 38 for a length of about 15 feet. The tactifier is sprayed from the trpigj onto the tumbling seed.

Then dry coating 40 of mixed high specific gravity material, hydrophilic substance and fertilizer is sprinkled through an opening 42 in covering 32 on the seed from the down stream end of the spray nozzles for about 10 feet. The seed are tumbled along the entire length of the 23 feet of the spike auger 24.

The coated seed are expelled from the auger 24 at exit 44 onto belt 46 of the conveyor box 48. The conveyor box 48 is 8 feet wide, 20 feet long, and 5 feet high 32. The conveyor belt 46 runs through the will conveyor box 48. Warm dry air is blown through the conveyor box 48 by fan 50.

It will be understood that a growth regulator fertilizer could also be sprinkled on the tacky seed. Also, fertilizer, hydrophilic material, and high specific gravity substance could be individually sprinkled on the seed. Also, any one or two of the three coating materials could be used.

Also, as a substitute or as a addition to the dried by placing the seed over a screen in a bin and blowing dry air upward through the screen. A dryer of this type is often referred to as a “peanut dryer”.

The embodiment shown and described above is only exemplary. I do not claim to have invented all the parts, elements or steps described. Various modifications can be made in the construction, material, arrangement, and operation, and still be within the scope of my invention.

The restrictive description and drawings of the specific examples above do not point out what an infringement of this patent would be, but are to point out the advantages and the progressive contribution to the art of planting small awny seed and to enable one skilled in the art to make and use the invention. The limits of the invention and the bounds of the patent protection are measured by and defined in the following claims.

I claim as my invention:

1 The method of preparing awny seed for planting, comprising:
a) chilling the awny seed to a temperature lower than 5° C. and
b) removing the awn from the seed.

2 The method as described in claim 1 further comprising
c) removing the awn by abrasion.

3 The method as described in claim 1, further comprising:
c) removing the awn by flaming the seed.

4 The method as defined in claim 1, further comprising:
c) after removing the awn, coating the seed with high specific gravity material.

5 The method as described as in claim 4 further comprising:
d) the high specific gravity magnets includes iron oxide iron.

6 The method as described in claim 4 further comprising:
d) the high specific gravity material includes sand.

7 The method as described in claim 4 further comprising:
d) the high specific gravity includes bentonite.

8 The method as described in claim 4 further comprising:
d) adding a hydrophilic substance to the high specific gravity material.

9 The method as defined in claim 8 further comprising:
e) the hydrophilic substance is polyacryamide.

10 The method as defined in claim 1 further comprising:
c) after removing the awn, applying a tactifier to the seed while
d) agitating the seed,
e) applying a high specific gravity material the side while agitating the seed.

11 The method as defied in claim 10 further compromising:
f) adding a hydrophilic substance to the highly specific gravity material before applying it to the seed.

12 A mechanism for chilling seed comprising:
a. a hopper connected to
b. an auger tube having
c. an auger extending through the auger tube, the auger drivingly connected to
d. a motor, and
e. a jacket surrounding the auger tube,
f. a chilling substance in the jacket.

13 g. The mechanism as defined in claim 12 further comprising the chilling substance including liquid nitrogen.

14 A machine including the mechanism as defined in claim 12 further comprising:
g. A flame tube having to flame tube having a vertical axis attached to and exit of anger tube, and a burner attached to the flame tube in a position to extend in to the flame tube.

15 The machine as defined in claim 4 wherein the chilling substance is liquid nitrogen.

16 A product for coating seed comprising:
a. a high specific gravity substance b&a hydrophilic material , and
c. a fertilizer.

17 The product as described in claim 16 wherein the high specific gravity substances includes bentonite, and the hydrophilic material includes polyacryamide, and a growth regulator is also included in the coating product.

18 The product as defined in the claim 17 wherein the products surrounds a seed from which awn has been removed.

19 The product as defined in claim 18 wherein the product includes a tackifier between the seed and coating.
